(19) United States
(12) Patent Application Publication
(10) Pub. No.: US 2024/0397512 A1
(43) Pub. Date: Nov. 28, 2024

(54) TECHNIQUES FOR COMMUNICATING IN A NETWORK WITH A NO-TRANSMIT ZONE

(71) Applicant: QUALCOMM Incorporated, San Diego, CA (US)

(72) Inventors: Le LIU, San Jose, CA (US); Kazuki TAKEDA, Minato-ku (JP); Chiranjib SAHA, Lakeside, CA (US); Umesh PHUYAL, San Diego, CA (US); Alberto RICO ALVARINO, San Diego, CA (US)

(21) Appl. No.: 18/668,689

(22) Filed: May 20, 2024

Related U.S. Application Data
(60) Provisional application No. 63/504,117, filed on May 24, 2023.

(51) Int. Cl. H04W 72/20

(52) U.S. Cl. CPC H04W 72/20

(57) ABSTRACT

Various aspects of the present disclosure generally relate to wireless communication. In some aspects, a user equipment (UE) may transmit an indication associated with a non-uplink transmission state for the UE. The UE may receive scheduling for one or more communications based at least in part on the indication. Numerous other aspects are described.

### CROSS-REFERENCE TO RELATED APPLICATION

This patent application claims priority to U.S. Provisional Patent Application No. 63/504,117, filed on May 24, 2023, entitled “TECHNIQUES FOR COMMUNICATING IN A NETWORK WITH A NO-TRANSMIT ZONE,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for communicating in a network with a no-transmit zone (NTZ).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include transmitting an indication associated with a non-uplink transmission state for the UE. In some aspects, the non-uplink transmission state may be associated with an entry of the UE into a no-transmit zone (NTZ). The method may include receiving scheduling for one or more communications based at least in part on the indication.

Some aspects described herein relate to a method of wireless communication performed by a network node. The method may include receiving an indication associated with a non-uplink transmission state for a UE. The method may include transmitting scheduling for one or more communications based at least in part on the indication.

Some aspects described herein relate to a UE for wireless communication. The UE may include one or more memories and one or more processors coupled to the one or more memories. The one or more processors may be configured to transmit an indication associated with a non-uplink transmission state for the UE. The one or more processors may be configured to receive scheduling for one or more communications based at least in part on the indication.

Some aspects described herein relate to a network node for wireless communication. The network node may include one or more memories and one or more processors coupled to the one or more memories. The one or more processors may be configured to receive an indication associated with a non-uplink transmission state for a UE. The one or more processors may be configured to transmit scheduling for one or more communications based at least in part on the indication.

Some aspects described herein relate to a non-transitory computer-readable medium that stores a set of instructions for wireless communication by a UE. The set of instructions, when executed by one or more processors of the UE, may cause the UE to transmit an indication associated with a non-uplink transmission state for the UE. The set of instructions, when executed by one or more processors of the UE, may cause the UE to receive scheduling for one or more communications based at least in part on the indication.

Some aspects described herein relate to a non-transitory computer-readable medium that stores a set of instructions for wireless communication by a network node. The set of instructions, when executed by one or more processors of the network node, may cause the network node to receive an indication associated with a non-uplink transmission state for a UE. The set of instructions, when executed by one or more processors of the network node, may cause the network node to transmit scheduling for one or more communications based at least in part on the indication.

Some aspects described herein relate to an apparatus for wireless communication. The apparatus may include means for transmitting an indication associated with a non-uplink transmission state for the apparatus, the non-uplink transmission state associated with an entry of the apparatus into an NTZ. The apparatus may include means for receiving scheduling for one or more communications based at least in part on the indication.

Some aspects described herein relate to an apparatus for wireless communication. The apparatus may include means for receiving an indication associated with a non-uplink transmission state for a UE. The apparatus may include means for transmitting scheduling for one or more communications based at least in part on the indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram of an example associated with non-transmit zones (NTZs), in accordance with the present disclosure.

FIG. 5 is a diagram illustrating examples of carrier aggregation, in accordance with the present disclosure.

FIG. 6 is a diagram of an example associated with communicating in a network with an NTZ, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some networks, a no-transmit zone (NTZ) may include an area or volume of space from which transmissions such as uplink communications from a user equipment (UE) are restricted. For example, an NTZ (e.g., a no-fly zone) may be imposed to limit transmissions from a UE (e.g., an aerial UE, such as a drone or Unmanned Aerial Vehicle) to reduce interference to a network or other electronic systems. For example, the NTZ may be used to reduce interference with systems and/or networks associated with radio astronomy, radar, and/or fixed satellite services, among other examples.

It may be desirable for a UE entering or in an NTZ to maintain a connection with a serving cell of the UE, such that the connection does not have to be reestablished, thereby incurring overhead. However, certain procedures or signaling may involve uplink transmission by the UE, and thus may fail (or be perceived by a network node to have failed based on receiving no transmission from the UE) in an NTZ. Without providing for the UE and the network node to come to a common understanding of a UE's transmission state, radio link failure may occur, thereby degrading throughput and performance of the network. Furthermore, signals or channels that were expected by the network node may be missed by the network node due to the UE's transmission state, thereby degrading throughput and performance of the network.

Various aspects relate generally to NTZs. Some aspects more specifically relate to UE transmission of an indication associated with a non-uplink transmission state. In some examples, the non-uplink transmission state may be based at least in part on an entry of the UE into an NTZ (e.g., based at least in part on anticipated entry into the NTZ or a current location being within the NTZ, among other examples). In some aspects, instead of using a pre-allocated dedicated uplink (UL) or supplemental uplink (SUL) carrier, a cell or carrier can be configured with no transmission of all or a subset of UL channels or reference signals based at least in part on the indication. In some aspects, the indication may indicate a UE request for a non-uplink transmission state (e.g., a request to be configured with the non-uplink transmission state) and/or a UE status (e.g., a non-uplink transmission state and/or location information associated with the NTZ, among other examples). In some examples, a network node may dynamically configure transmission of an uplink channel or signal, which was to be transmitted on a cell or carrier configured for no transmission, on another cell or carrier that does not have an NTZ restriction.

Particular aspects of the subject matter described in this disclosure can be implemented to realize one or more of the following potential advantages. In some examples, by transmitting an indication associated with the non-uplink transmission state of the UE, the described techniques can be used to comply with NTZ rules and/or to maintain a connection between the UE and the network node. In this way, the UE may avoid a radio link failure (RLF), which may conserve network, communication, power, and/or computing resources that may have otherwise been used to perform an RLF recovery procedure. By dynamically configuring transmission of an uplink channel or signal, which was to be transmitted on a cell or carrier configured for no transmission, on another cell or carrier that does not have an NTZ restriction, interruption of uplink channels or signals is reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

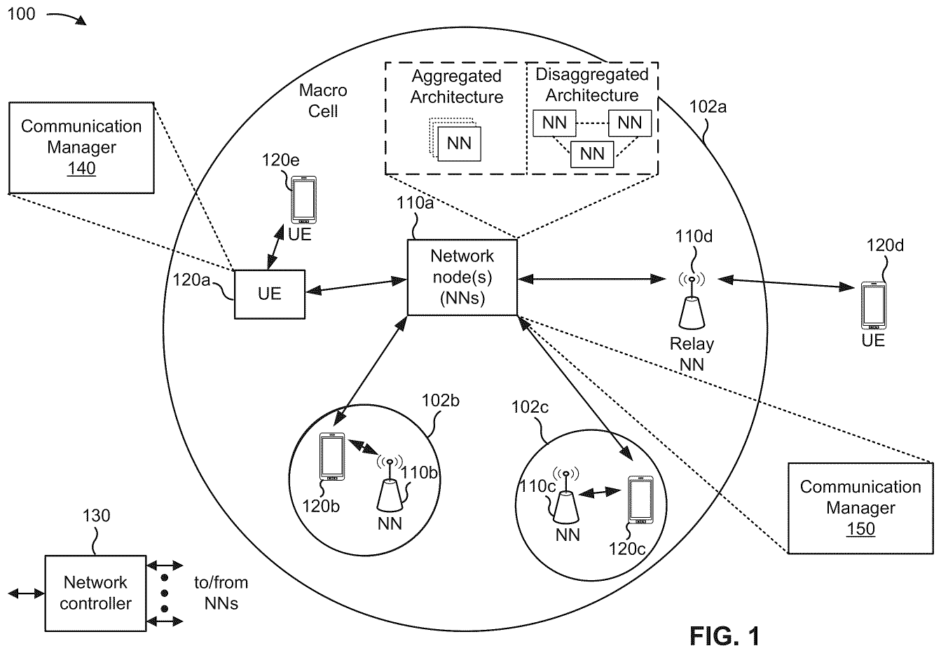

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit an indication associated with a non-uplink transmission state for the UE; and receive scheduling for one or more communications based at least in part on the indication. Additionally, or alternatively, the communication manager 140 may perform one or more other operations described herein.

In some aspects, the network node 110 may include a communication manager 150. As described in more detail elsewhere herein, the communication manager 150 may receive an indication associated with a non-uplink transmission state for a UE; and transmit scheduling for one or more communications based at least in part on the indication. Additionally, or alternatively, the communication manager 150 may perform one or more other operations described herein.

As indicated above, FIG. 1 is provided as an example. Other examples may differ from what is described with regard to FIG. 1.

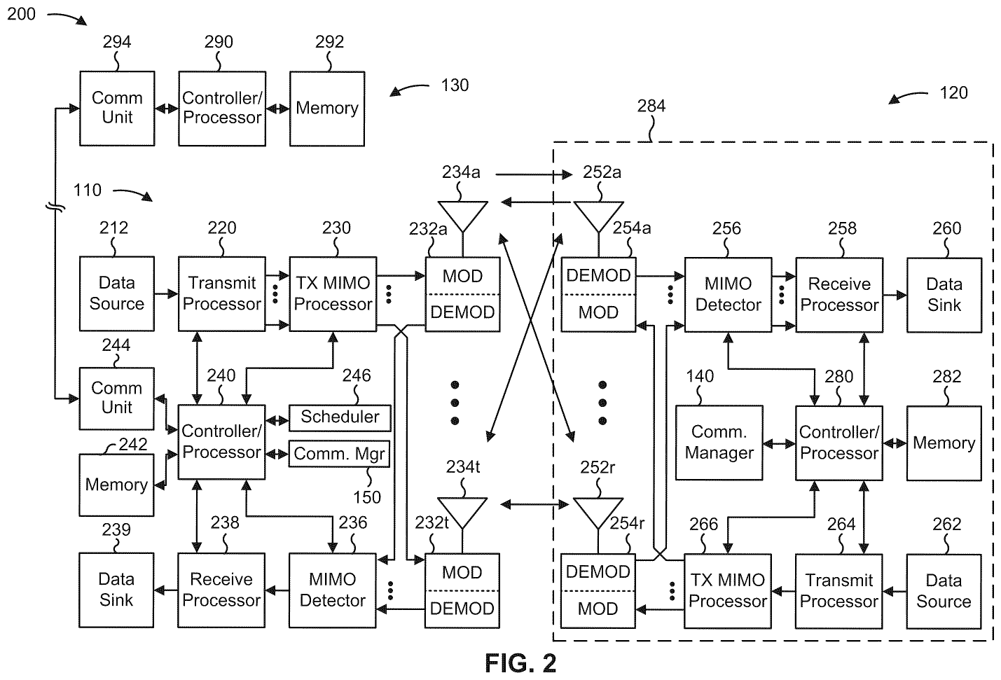

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

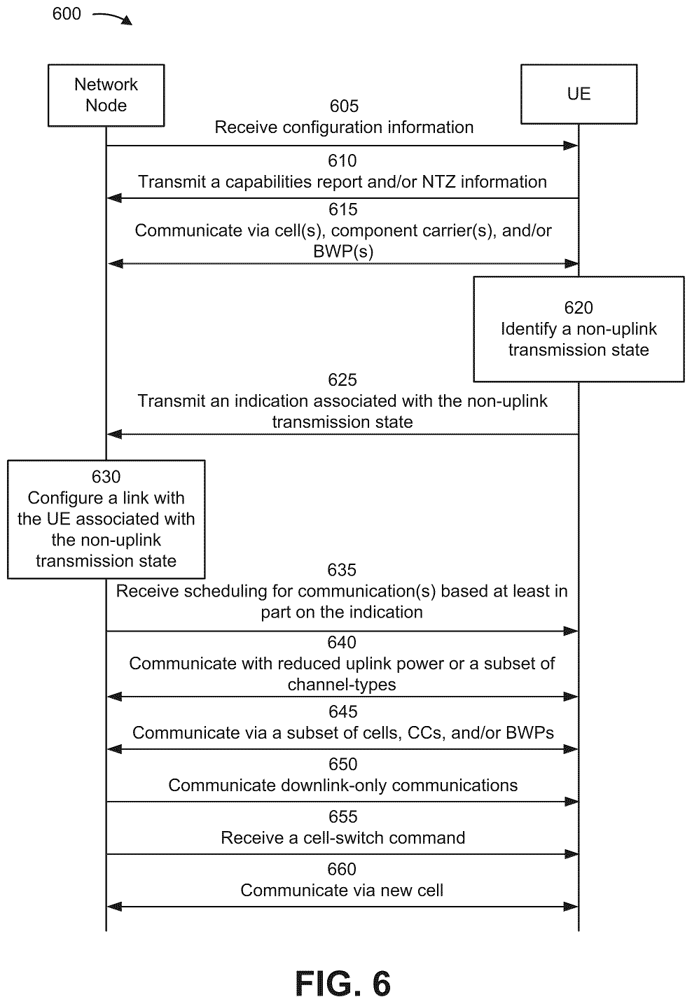

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

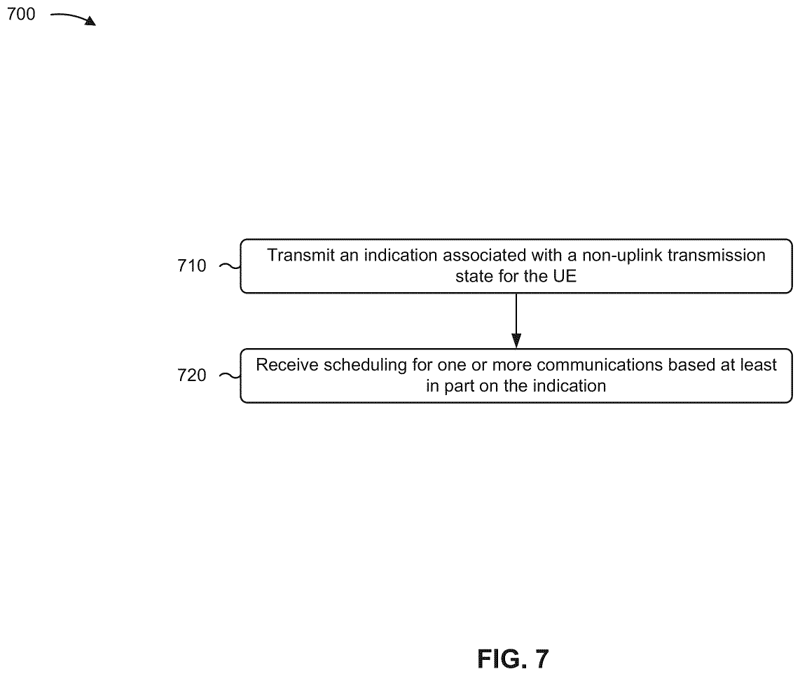

The controller/processor 240 of the network node 110, the controller/processor 280 of the UE 120, or any other component(s) of FIG. 2 may perform one or more techniques associated with communicating in a network with NTZs, as described in more detail elsewhere herein. For example, the controller/processor 240 of the network node 110, the controller/processor 280 of the UE 120, or any other component(s) (or combinations of components) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting an indication associated with a non-uplink transmission state for the UE; and/or means for receiving scheduling for one or more communications based at least in part on the indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving an indication associated with a non-uplink transmission state for a UE; and/or means for transmitting scheduling for one or more communications based at least in part on the indication. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

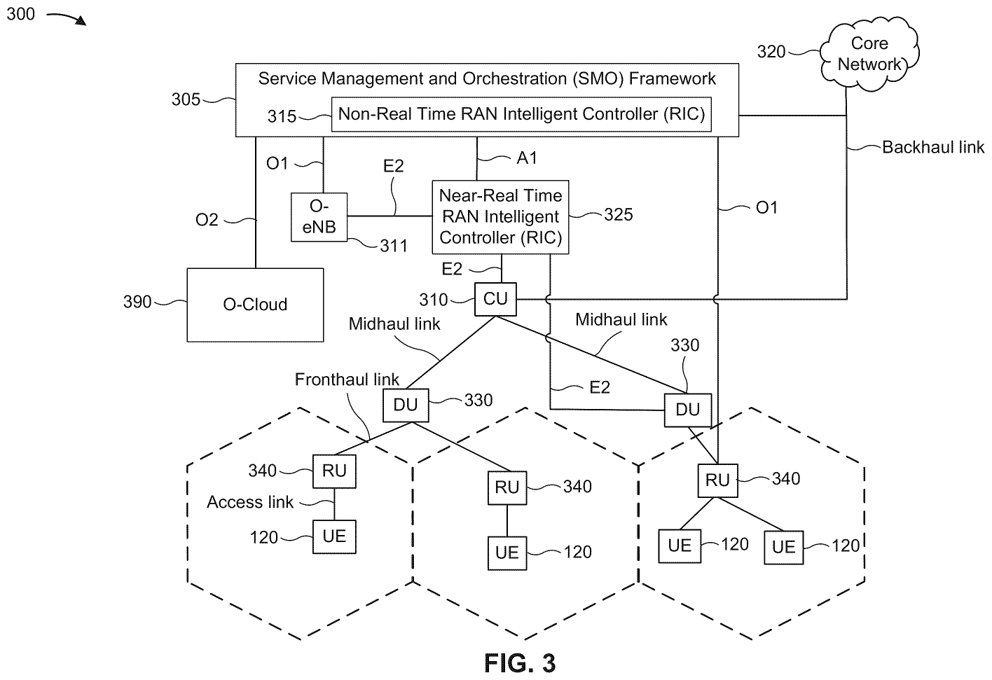

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through FI interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

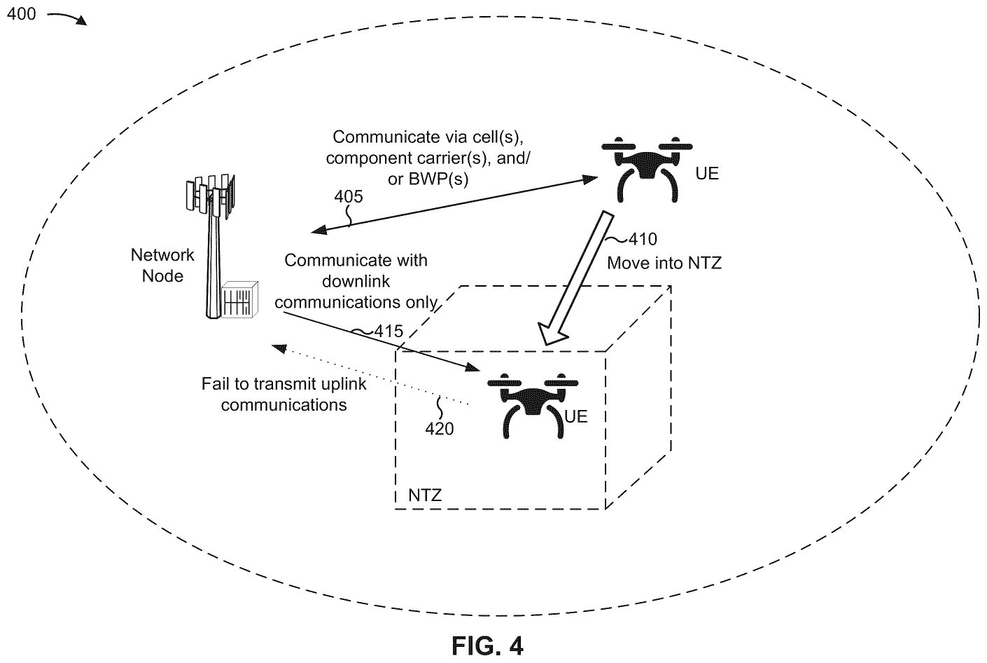

FIG. 4 is a diagram of an example 400 associated with NTZs, in accordance with the present disclosure. As shown in FIG. 4, a network node (e.g., network node 110, a CU, a DU, and/or an RU) may communicate with a UE (e.g., UE 120). In some networks, the network node and the UE may be part of a wireless network (e.g., wireless network 100). The UE and the network node may have established a wireless connection prior to operations shown in FIG. 4. Also shown in FIG. 4, the UE may include an aerial UE, such as a drone.

As shown by reference number 405, the UE and the network node may communicate via one or more cells, one or more component carriers, and/or one or more bandwidth parts (BWPs). As shown in FIG. 4, communication associated with reference number 405 occurs when the UE is outside of an NTZ.

As shown by reference number 410, the UE may move into the NTZ. For example, the UE may be controlled by a user or a pre-defined flight path that instructs the UE to enter the NTZ. The UE may be aware of the NTZ and that the UE may have restrictions for transmitting uplink communications.

The NTZ may be imposed to limit the transmissions from drones to, for example, reduce or avoid interference to a nearby network node. In some aspects, the interference may be associated with systems or networks that operate at the same frequency band as the wireless network or at a harmonic to the frequency band of the wireless network. For example, the systems or networks may be associated with radio astronomy, radars, and/or fixed satellite services, among other examples.

As shown by reference number 415, the UE and the network node may communicate with downlink communications only while the UE is within the NTZ. For example, the UE may continue to receive movement instructions via the network node.

As shown by reference number 420, the UE may fail to transmit uplink communications based at least in part on being within the NTZ. For example, the UE may fail to transmit data (e.g., images and/or audio captured via a device of the UE), control information, beamforming information, and/or hybrid automatic repeat request (HARQ) acknowledgment (HARQ-ACK) information associated with received downlink communications, among other examples.

As indicated above, FIG. 4 is provided as an example. Other examples may differ from what is described with regard to FIG. 4.

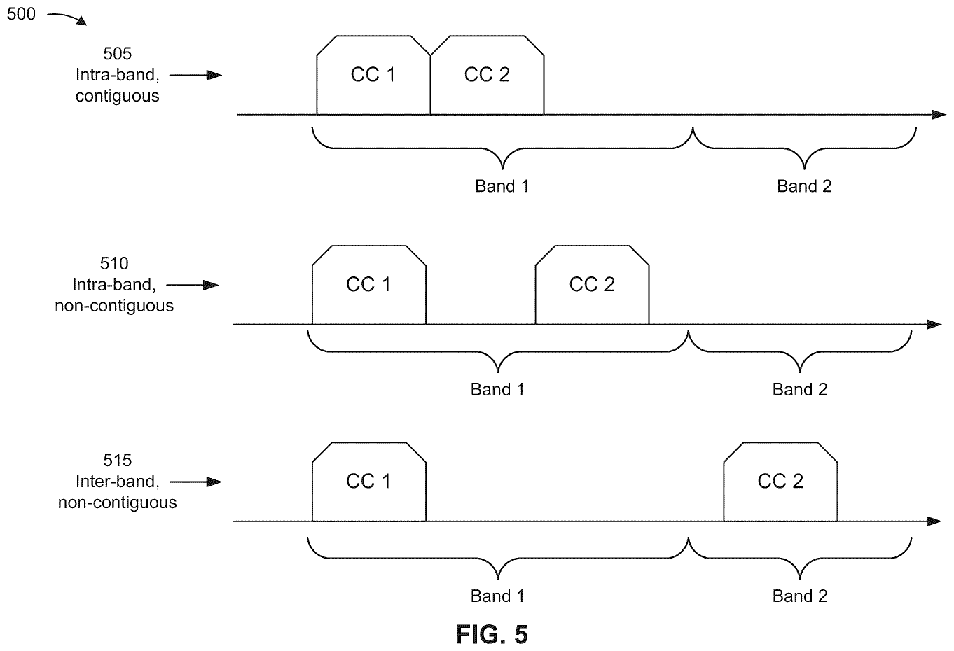

FIG. 5 is a diagram illustrating examples 500 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, downlink control information (DCI), and/or another signaling message.

As shown by reference number 505, in some aspects, carrier aggregation may be configured in an intra-band contiguous mode where the aggregated carriers are contiguous to one another and are in the same band. As shown by reference number 510, in some aspects, carrier aggregation may be configured in an intra-band non-contiguous mode where the aggregated carriers are non-contiguous to one another and are in the same band. As shown by reference number 515, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., DCI and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 5 is provided as an example. Other examples may differ from what is described with regard to FIG. 5.

In some networks, the network may operate a set of channels (frequency bandwidths). The set of channels may include frequency domain duplexing (FDD) channels, time-division duplexing (TDD) channels, SUL channels, and/or supplemental downlink (SDL) channels, among other examples. The SUL channels may be supplementary within a link that includes at least one TDD or FDD channel, where the SUL channels are used for only uplink communications. Similarly, the SDL channels may be supplementary within a link that includes at least one TDD or FDD channel, where the SDL channels are used for only downlink communications.

In some networks, carrier aggregation (CA)-based cross carrier scheduling and/or cell switching may be supported between a PCell and an SCell. For example, in some communication protocols, physical uplink shared channel (PUSCH) and/or sounding reference signal (SRS) cross-carrier scheduling may be supported between a PCell and an SCell. In some examples, PUSCH and/or SRS dynamic cross-carrier scheduling may be based at least in part on a carrier indicator field in, for example, uplink DCI format 0_1 and/or 0_2, enabled by an RRC parameter (e.g., CrossCarrierSchedulingConfig).

In some communication protocols, physical uplink control channel (PUCCH) cell switching may be supported between a PCell and another cell referred to as a PUCCH switching SCell (sSCell). PUCCH periodic cell switching for any uplink control information (UCI) (e.g., for a TDD PCell) may be based at least in part on a periodic pattern, which may be configured by an RRC parameter (e.g., pucch-sSCellPattern). PUCCH dynamic cell switching for a HARQ-ACK of an associated physical downlink shared channel (PDSCH) communication may be based at least in part on a PUCCH cell indicator in, for example, downlink DCI format 1_1 and/or 1_2, if enabled by an RRC parameter (e.g., pucch-sSCellDyn).

In some communication protocols, uplink and SUL carrier switching may be supported. For example, PRACH, PUSCH, and/or SRS carrier switching may be supported between uplink and SUL channels. PRACH dynamic carrier switching may be based at least in part on a field of downlink DCI format 1_0 (e.g., UL/SUL indicator). PUSCH dynamic carrier switching may be based at least in part a field of uplink DCI format 0_0, 0_1, and/or 0_2 (e.g., UL/SUL indicator). SRS dynamic carrier switching may be based at least in part on 1 bit of an SRS request field in downlink DCI format 1_1/1_2 or UL DCI format 0_1/0_2. However, PUCCH dynamic carrier switching may not be supported between UL and SUL. For example, only PUCCH semi-static carrier switching may be supported, where PUCCH-Config is configured in uplink channels or supplemental uplink carriers, but not both.

In some communication protocols, BWP switching may be supported. For example, PUSCH and/or SRS BWP switching may be supported between BWPs. PUSCH dynamic BWP switching may be based at least in part a field of uplink DCI format 0_1 and/or 0_2 (e.g., Bandwidth part indicator). SRS dynamic BWP switching may be based at least in part on BWP indicator and an SRS request field in downlink DCI format 1_1/1_2 or UL DCI format 0_1/0_2.

In some aspects described herein, a UE may support maintaining a connection with a serving cell (e.g., not for cell reselection, cell selection, or handover) when in an NTZ. For example, the UE may support receiving downlink communications within the NTZ, even when the UE is restricted for uplink communications.

In some aspects, the UE may transmit an indication associated with a non-uplink transmission state of the UE. The non-uplink transmission state may be associated with entry of the UE to an NTZ. In some aspects, the indication may include a request for no transmission of uplink channel and/or reference signals in a cell, a component carrier, and/or a BWP. A network node may configure no transmission resources for the uplink channel and/or reference signals in the cell, component carrier or BWP based at least in part the UE request. For example, based at least in part on the UE having a configuration associated with the NTZ, and the UE detecting entry (e.g., actual entry or expected entry) into the NTZ, the UE may indicate to the network node which cell, component carrier or BWP to temporarily enable or disable transmission of the uplink channel and/or reference signals. Additionally, or alternatively, the UE may transmit an indication of a corresponding starting time and/or time duration during which the UE is to remain in the non-uplink transmission state (e.g., based at least in part on an expected start time and/or duration of remaining in the NTZ). In some aspects, the UE may transmit the indication via RRC signaling, as UE assistance information, and/or via a MAC control element (CE).

In some aspects, the UE may transmit an indication (e.g., a report) of a UE status, and the network node may determine whether to apply a configuration with no transmission of uplink channel and/or reference signal transmissions in a cell, component carrier or BWP based at least in part on the UE status. For example, based at least in part on the network node having the NTZ configuration and/or based at least in part on a UE status that includes a reported location of the UE, the network node may identify a cell, component carrier or BWP to temporarily configure with no transmission of uplink channel and/or reference signal transmissions. The UE may transmit the indication of the UE status via MAC CE or by RRC signaling, separately or together with other measurement and reporting results, among other examples.

In some aspects, the NTZ configuration may apply to a proper subset of cells, component carriers, bands, and/or BWPs for transmission of one or more uplink channels and/or reference signals. In some aspects, the NTZ configuration may be associated with a height threshold (e.g., where the NTZ is applied only to aerial UEs). For example, a network may use 2-dimensional (2D) or 3-dimensional (3D) geofencing of an area or volume of space (e.g., only within a geographic area and/or at a minimum elevation). In some aspects, the NTZ configuration provides a power restriction, such as a maximum transmission power, a power mask, and/or a power backoff if non-zero power is allowed within the NTZ. In some aspects, the NTZ configuration applies to the area or volume of space during time durations. For example, the NTZ configuration may apply only during certain days of the week and/or at certain times of the day.

In some aspects, parameters of the NTZ configuration may be configured by a serving cell, a mobility management entity (MME), and/or an access and mobility management function (AMF). For example, the UE and/or the network node may receive the NTZ configuration from the MME or the AMF (e.g., directly or directionally) when the UE sends aerial UE subscription information to the MME or the AMF. Similarly, the network node may receive the NTZ configuration from the MME or the AMF and configure the reporting for the UE with subscription information registered in the MME or the AMF.

Instead of using a pre-allocated dedicated UL/SUL carrier, a cell, a component carrier, and/or a BWP may be configured with no transmission of all or a subset of UL channels/reference signals (RSs) based on a condition, where the condition is dependent on a UE request or the UE status. In some aspects, when an NTZ restriction to an uplink channel and/or reference signal transmission is applied to a cell, a component carrier, and/or a BWP, the network node may dynamically configure transmission of the uplink channel and/or reference signals to another cell or carrier without the NTZ restriction. For example, to schedule a PUSCH and/or SRS transmission on a BWP, the network node may reuse DCI-based dynamic indications for uplink BWP switching or BWP change. For example, to schedule a PUSCH and/or SRS transmission on an SCell, the network node may reuse DCI-based dynamic indications for uplink carrier aggregation cross-carrier scheduling. To schedule a PUCCH transmission on the SCell, the network node may reuse a PUCCH-sSCell configuration and/or DCI-based dynamic indication for PUCCH cell switching. To schedule a PUCCH transmission on an uplink carrier, to support dynamic carrier switching between uplink and SUL, the network node may support PUCCH-Config to be configured on both of the uplink and the SUL. In some aspects, the network node may configure pucch-sSCellPattern on uplink and SUL as a nominal ‘SCell’. The network node may reuse the DCI bit for dynamic PUCCH cell switching between uplink and SUL. In some aspects, the PUCCH switching cell may be a PCell. For example, pucch-sSCellPattern may be extended to pucch-sCellPattern including a cell, where the cell can be a PCell and/or an SCell. In some aspects, PRACH transmission may be allowed to be transmitted in a cell, where the cell can be PCell and/or an SCell. To schedule a PRACH transmission on the (pre-) configured cell, the network node may configure a PRACH-sCell configuration and/or DCI-based dynamic indication for PRACH cell switching. To schedule a PRACH transmission on an uplink carrier, to support dynamic carrier switching between uplink and SUL, the network node may support RACH configuration such as rach-ConfigCommon or rach-ConfigDedicated in UL BWP to be configured on both of the uplink and the SUL. In some aspects, the network node may configure prach-sCellPattern on uplink and SUL as a nominal ‘Cell’. The network node may reuse the DCI bit for dynamic PRACH cell switching between uplink and SUL. In some aspects, the network may configure no uplink transmission to a subset of uplink channels/reference signals (RSs) in a cell, a component carrier, and/or a BWP based at least in part on the UE request or the UE status, (e.g., no transmission of PUSCH but PUCCH, and/or SRS is still allowed).

Based at least in part on transmitting an indication associated with the non-uplink transmission state of the UE, the described techniques can be used to comply with NTZ rules and/or to maintain a connection between the UE and the network node. In this way, the UE may avoid an RLF, which may conserve network, communication, power, and/or computing resources that may have otherwise been used to perform an RLF recovery procedure. Additionally, or alternatively, the UE may receive an indication (e.g., in response to the indication associated with the non-uplink transmission state of the UE) of an available uplink resource on a different cell, component carrier, and/or BWP, which may allow the UE to transmit an uplink communication that may have otherwise been prevented based at least in part on the NTZ.

FIG. 6 is a diagram of an example 600 associated with communicating in a network with an NTZ, in accordance with the present disclosure. As shown in FIG. 6, a network node (e.g., network node 110, a CU, a DU, and/or an RU) may communicate with a UE (e.g., UE 120). In some aspects, the network node and the UE may be part of a wireless network (e.g., wireless network 100). The wireless network may include an NTZ with restrictions on uplink transmissions by UEs. The UE and the network node may have established a wireless connection prior to operations shown in FIG. 6. In some aspects, the UE may include an aerial UE, such as a drone.

As shown by reference number 605, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit an indication associated with a non-uplink transmission state for the UE to indicate, to the network node, that the UE is to be configured and/or scheduled based at least in part on restrictions associated with the non-uplink transmission state. The configuration information may indicate that the non-uplink transmission state is associated with an NTZ within the cell. In some aspects, the configuration information may indicate a location of the NTZ. In some aspects, the configuration information may indicate a communication type for the UE to use to transmit the indication associated with the non-uplink transmission state for the UE. In some aspects, the configuration information may indicate one or more parameters for communicating within the NTZ.

The UE may configure itself based at least in part on the configuration information. In some aspects, the UE may be configured to perform one or more operations described herein based at least in part on the configuration information.

As shown by reference number 610, the UE may transmit, and the network node may receive, a capabilities report. In some aspects, the capabilities report may indicate UE support for one or more types of communication within the NTZ. In some aspects, the capabilities report may indicate communication capabilities of the UE, such as supported channels, BWPs, frequency ranges (FRs), and/or switching times to configure the UE for cell switching, among other examples.

As shown by reference number 615, the UE and the network node may communicate via one or more cells, one or more component carriers, and/or one or more BWPs, among other examples. For example, the UE and the network node may communicate with a set of frequency resources when the UE is outside of the NTZ.

As shown by reference number 620, the UE may identify a non-uplink transmission state. For example, the UE may identify a location of the UE as being within the NTZ, within a radius of the NTZ, and/or changing to indicate a likelihood of entering the NTZ, among other examples. In some aspects, the NTZ may be associated with restrictions on uplink transmissions of UEs from within the NTZ.

In some aspects, a link between the UE and a network node includes multiple cells, and the non-uplink transmission state is associated with a proper subset of the multiple cells. In some aspects, the link between the UE and the network node includes multiple component carriers and the non-uplink transmission state is associated with a proper subset of the multiple component carriers. In some aspects, the link between the UE and the network node includes multiple BWPs and the non-uplink transmission state is associated with a proper subset of the multiple BWPs.

As shown by reference number 625, the UE may transmit, and the network node may receive, an indication associated with the non-uplink transmission state. In some aspects, the indication may include a duration of time and/or a start time associated with the non-uplink transmission state. In some aspects, the UE may transmit the indication associated with the non-uplink transmission state via an RRC communication, a MAC CE indication, and/or UE assistance information, among other examples.

In some aspects, the indication associated with the non-uplink transmission state may include a request to initiate the non-uplink transmission state, position information associated with a location of the UE, and/or an indication of the non-uplink transmission state, among other examples. For example, the indication may indicate a location of the UE and/or an elevation of the UE (e.g., the position information) and/or an indication that the UE is in an NTZ or expects to be within the NTZ (e.g., an indication of the non-uplink transmission state).

As shown by reference number 630, the network node may configure a link with the UE associated with the non-uplink transmission state. For example, the network node may configure the link to prohibit uplink transmissions for a period of time and/or until receiving a subsequent request to reinstate uplink communications.

In some aspects, the network node may configure the link to add one or more channels, component carriers, cells, and/or BWPs to the link based at least in part on the indication associated with the non-uplink transmission state. In some aspects, the network node may configure the link the remove one or more channels, component carriers, cells, and/or BWPs from the link based at least in part on the indication associated with the non-uplink transmission state.

In some aspects, the network node may configure the link based at least in part on a location of the UE, an elevation of the UE, and/or a current time (e.g., time of the day, day of the week, date of the month, and/or date of the year, among other examples).

As shown by reference number 635, the UE may receive, and the network node may transmit, scheduling for one or more communications based at least in part on the indication associated with the non-uplink transmission state. In some aspects, the UE may receive the scheduling via a DCI message and/or a configuration of an sSCell.

In some aspects, the scheduling may include an allocation for one or more uplink communications via a cell of a link between the UE and the network node that does not have the NTZ restriction or otherwise supports uplink communications while the UE is in the NTZ.

In some aspects, the scheduling may indicate to perform a cell switch to a new cell to use one or more resources of the new cell for one or more uplink communications. In some aspects, the scheduling may indicate an allocation for one or more uplink communications via a cell of the link between the UE and network node that is not included in the proper subset of cells that prohibit uplink transmissions.

In some aspects, the scheduling may be based at least in part on the indication associated with the non-uplink transmission state, a location of the UE, an elevation of the UE, and/or a current time (e.g., time of the day, day of the week, date of the month, and/or date of the year, among other examples), among other examples.

As shown by reference number 640, the UE and the network node may communicate with a reduced uplink power and/or a subset of channel-types (e.g., based at least in part on the scheduling). For example, the NTZ may be associated with a UE transmission power limit. In some aspects, the UE may support transmission of one or more channel types (e.g., random access channel (RACH), SRS, and/or PUCCH, among other examples) within the transmission restrictions of the NTZ. In some aspects, the UE may support an MCS that satisfies a threshold when the UE is within the NTZ (e.g., an MCS that has a low enough modulation order and/or coding rate to be received when transmitted with low transmission power).

As shown by reference number 645, the UE and the network node may communicate via a subset (e.g., a proper subset) of cells, CCs, and/or BWPs (e.g., based at least in part on the scheduling). In some aspects, the subset of the cells, component carriers, and/or BWPs may be a proper subset of cells, component carriers, and/or BWPs that were used for communications before entering the NTZ (e.g., communications described in connection with reference number 615).

In some aspects, communicating via a subset may be an alternative to, or may be used in addition to, communication described in connection with reference number 640.

As shown by reference number 650, the UE and the network node may communicate with downlink-only communications. For example, all uplink transmissions may be prohibited based at least in part on the scheduling. In some aspects, communicating via downlink-only communications may be an alternative to, or may be used in addition to, communication described in connection with reference numbers 640 and/or 645.

As shown by reference number 655, the UE may receive, and the network node may transmit, a cell-switch command. For example, the network node may indicate that the UE is to switch to a cell and/or component carrier that supports uplink transmission while the UE is in the NTZ.

As shown by reference number 660, the UE and the network node may communicate via a new cell. For example, the UE and the network node may communicate via a new cell indicated in the cell-switch command. In some aspects, communicating receiving a cell-switching command and/or communicating via the new cell may be an alternative to, or may be used in addition to, any of the communications described in connection with reference numbers 640-650.

As described in connection with reference numbers 640-660, the UE may receive scheduling for one or more communications based at least in part on the indication associated with the non-uplink transmission state. The UE and the network node may then communicate based at least in part on the indication associated with the non-uplink transmission state and/or the scheduling.

Based at least in part on transmitting the indication associated with the non-uplink transmission state of the UE, the described techniques can be used to comply with NTZ rules and/or to maintain a connection between the UE and the network node. In this way, the UE may avoid an RLF and/or allow the UE to transmit uplink communications and/or reference signals, which may conserve network, communication, power, and/or computing resources that may have otherwise been used to perform an RLF recovery procedure or recover from failed uplink transmissions.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with techniques for communicating in a network with an NTZ.

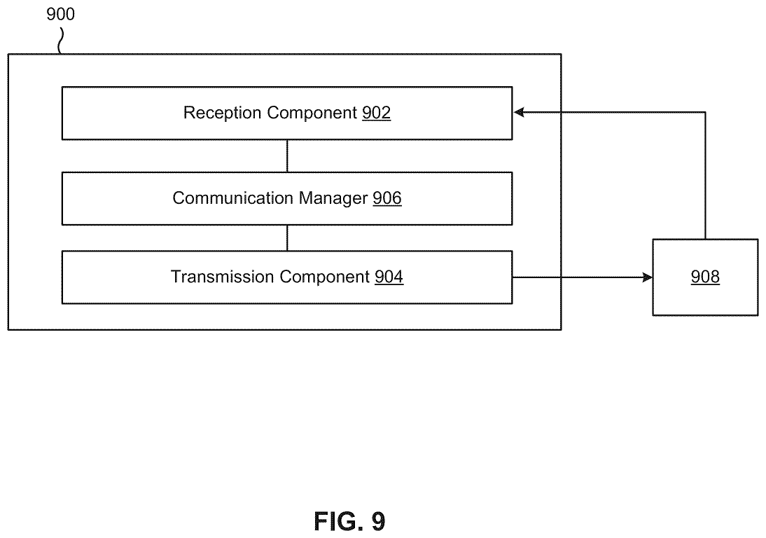

As shown in FIG. 7, in some aspects, process 700 may include transmitting an indication associated with a non-uplink transmission state for the UE (block 710). For example, the UE (e.g., using transmission component 904 and/or communication manager 906, depicted in FIG. 9) may transmit an indication associated with a non-uplink transmission state for the UE, as described above.

As further shown in FIG. 7, in some aspects, process 700 may include receiving scheduling for one or more communications based at least in part on the indication (block 720). For example, the UE (e.g., using reception component 902 and/or communication manager 906, depicted in FIG. 9) may receive scheduling for one or more communications based at least in part on the indication, as described above.

Process 700 may include additional aspects, such as any single aspect or any combination of aspects described below and/or in connection with one or more other processes described elsewhere herein.

In a first aspect, the indication associated with the non-uplink transmission state for the UE comprises a request to initiate the non-uplink transmission state, positioning information associated with a location of the UE, or an indication of the non-uplink transmission state.

In a second aspect, the indication of the non-uplink transmission state comprises an indication of one or more of a location of the UE, or an elevation of the UE.

In a third aspect, the one or more communications comprise one or more of only downlink communications, uplink communications having reduced transmission power, uplink communications associated with a proper subset of channel-types, or uplink reference signals.

In a fourth aspect, the indication associated with the non-uplink transmission state is associated with one or more of one or more cells, one or more component carriers, one or more channel-types, or one or more bandwidth parts.

In a fifth aspect, a link between the UE and a network node includes multiple cells and the non-uplink transmission state is associated with a proper subset of the multiple cells, the link between the UE and the network node includes multiple component carriers and the non-uplink transmission state is associated with a proper subset of the multiple component carriers, or the link between the UE and the network node includes multiple BWPs and the non-uplink transmission state is associated with a proper subset of the multiple BWPs.

In a sixth aspect, receiving the scheduling for the one or more communications comprises receiving an allocation for one or more uplink communications via a cell of the multiple cells that is not included in the proper subset.

In a seventh aspect, receiving the scheduling for the one or more communications comprises receiving one or more of an indication to perform a cell switch to a new cell to use one or more resources of the new cell for one or more uplink communications, or an indication of an allocation for one or more uplink communications via a cell of the multiple cells that is not included in the proper subset.

In an eighth aspect, receiving the indication of the allocation for the one or more uplink communications via the cell that is not included in the proper subset comprises receiving the indication of the allocation via one or more of a DCI message, or a configuration of an sSCell.

In a ninth aspect, transmitting the indication associated with the non-uplink transmission state comprises transmitting the indication via one or more of an RRC communication, a MAC CE indication, or UE assistance information.

In a tenth aspect, the UE comprises an aerial UE.

In an eleventh aspect, the scheduling for the one or more communications comprises scheduling for the one or more communications with one or more parameters associated with the non-uplink transmission state based at least in part on one or more of a location of the UE, an elevation of the UE, or a current time of day.

In a twelfth aspect, the scheduling for the one or more communications is based at least in part on one or more parameters associated with the non-uplink transmission state, and the one or more parameters are based at least in part on a configuration from a network node.

In a thirteenth aspect, the non-uplink transmission state is associated with an entry of the UE into an NTZ.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

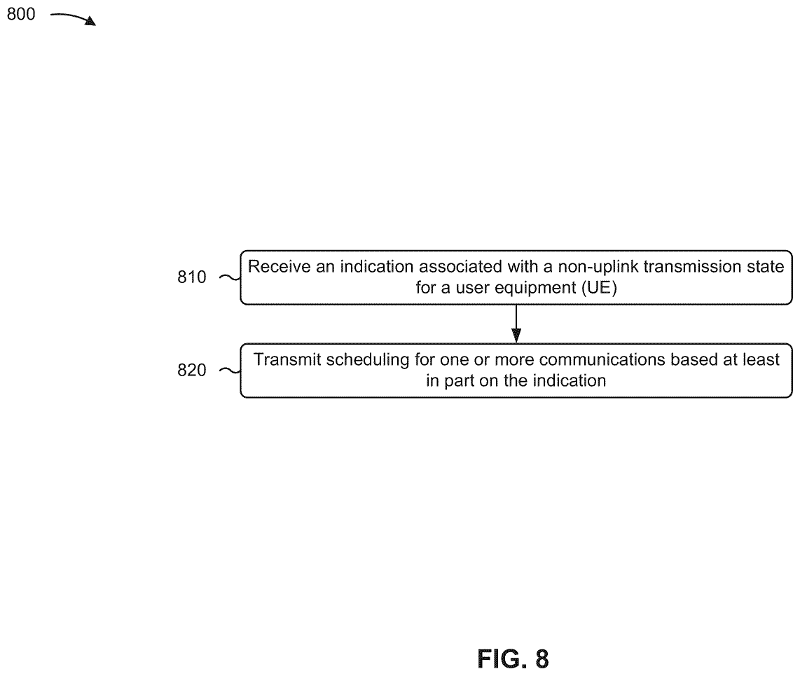

FIG. 8 is a diagram illustrating an example process 800 performed, for example, by a network node, in accordance with the present disclosure. Example process 800 is an example where the network node (e.g., network node 110) performs operations associated with techniques for communicating in a network with an NTZ.

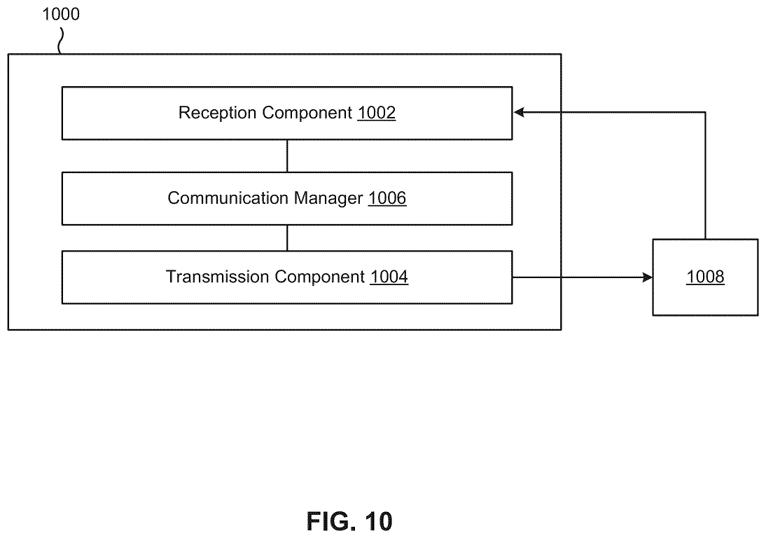

As shown in FIG. 8, in some aspects, process 800 may include receiving an indication associated with a non-uplink transmission state for a UE (block 810). For example, the network node (e.g., using reception component 1002 and/or communication manager 1006, depicted in FIG. 10) may receive an indication associated with a non-uplink transmission state for a UE, as described above.

As further shown in FIG. 8, in some aspects, process 800 may include transmitting scheduling for one or more communications based at least in part on the indication (block 820). For example, the network node (e.g., using transmission component 1004 and/or communication manager 1006, depicted in FIG. 10) may transmit scheduling for one or more communications based at least in part on the indication, as described above.

Process 800 may include additional aspects, such as any single aspect or any combination of aspects described below and/or in connection with one or more other processes described elsewhere herein.

In a first aspect, the indication associated with the non-uplink transmission state for the UE comprises a request to initiate the non-uplink transmission state, positioning information associated with a location of the UE, or an indication of the non-uplink transmission state.

In a second aspect, the indication associated with the non-uplink transmission state comprises an indication of one or more of a location of the UE, or an elevation of the UE.

In a third aspect, the one or more communications comprise one or more of only downlink communications, uplink communications having reduced transmission power, uplink communications associated with a proper subset of channel-types, or uplink reference signals.

In a fourth aspect, the indication of the non-uplink transmission state is associated with one or more of one or more cells, one or more component carriers, one or more channel-types, or one or more bandwidth parts.

In a fifth aspect, a link between the UE and the network node includes multiple cells and the non-uplink transmission state is associated with a proper subset of the multiple cells, the link between the UE and the network node includes multiple component carriers and the non-uplink transmission state is associated with a proper subset of the multiple component carriers, or the link between the UE and the network node includes multiple BWPs and the non-uplink transmission state is associated with a proper subset of the multiple BWPs.

In a sixth aspect, transmitting the scheduling for the one or more communications comprises transmitting an allocation for one or more uplink communications via a cell of the multiple cells that is not included in the proper subset.

In a seventh aspect, transmitting the scheduling for the one or more communications comprises transmitting one or more of an indication to perform a cell switch to a new cell to use one or more resources of the new cell for one or more uplink communications, or an indication of an allocation for one or more uplink communications via a cell of the multiple cells that is not included in the proper subset.

In an eighth aspect, transmitting the indication of the allocation for the one or more uplink communications via the cell that is not included in the proper subset comprises transmitting the indication of the allocation via one or more of a DCI message, or a configuration of an sSCell.

In a ninth aspect, receiving the indication associated with the non-uplink transmission state comprises receiving the indication via one or more of an RRC communication, a MAC CE indication, or UE assistance information.

In a tenth aspect, the UE comprises an aerial UE.

In an eleventh aspect, the scheduling for the one or more communications comprises scheduling for the one or more communications with one or more parameters associated with the non-uplink transmission state based at least in part on one or more of a location of the UE, an elevation of the UE, or a current time of day.

In a twelfth aspect, the scheduling for the one or more communications is based at least in part on one or more parameters associated with the non-uplink transmission state, and the one or more parameters are based at least in part on a configuration transmitted from the network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an indication associated with a non-uplink transmission state for the UE. The reception component 902 may receive scheduling for one or more communications based at least in part on the indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an indication associated with a non-uplink transmission state for a UE. The transmission component 1004 may transmit scheduling for one or more communications based at least in part on the indication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting an indication associated with a non-uplink transmission state for the UE; and receiving scheduling for one or more communications based at least in part on the indication.

Aspect 2: The method of Aspect 1, wherein the indication associated with the non-uplink transmission state for the UE comprises: a request to initiate the non-uplink transmission state, position information associated with a location of the UE, or an indication of the non-uplink transmission state.

Aspect 3: The method of Aspect 2, wherein the indication of the non-uplink transmission state comprises an indication of one or more of: a location of the UE, or an elevation of the UE.

Aspect 4: The method of any of Aspects 1-3, wherein the one or more communications comprise one or more of: only downlink communications, uplink communications having reduced transmission power, uplink communications associated with a proper subset of channel-types, or uplink reference signals.

Aspect 5: The method of any of Aspects 1-4, wherein the indication associated with the non-uplink transmission state is associated with one or more of: one or more cells, one or more component carriers, one or more channel-types, or one or more bandwidth parts.

Aspect 6: The method of any of Aspects 1-5, wherein a link between the UE and a network node includes multiple cells and wherein the non-uplink transmission state is associated with a proper subset of the multiple cells, wherein the link between the UE and the network node includes multiple component carriers and wherein the non-uplink transmission state is associated with a proper subset of the multiple component carriers, or wherein the link between the UE and the network node includes multiple bandwidth parts (BWPs) and wherein the non-uplink transmission state is associated with a proper subset of the multiple BWPs.

Aspect 7: The method of Aspect 6, wherein receiving the scheduling for the one or more communications comprises receiving an allocation for one or more uplink communications via a cell of the multiple cells that is not included in the proper subset.

Aspect 8: The method of Aspect 6, wherein receiving the scheduling for the one or more communications comprises receiving one or more of: an indication to perform a cell switch to a new cell to use one or more resources of the new cell for one or more uplink communications, or an indication of an allocation for one or more uplink communications via a cell of the multiple cells that is not included in the proper subset.

Aspect 9: The method of Aspect 8, wherein receiving the indication of the allocation for the one or more uplink communications via the cell that is not included in the proper subset comprises receiving the indication of the allocation via one or more of: a downlink control information (DCI) message, or a configuration of a switching secondary cell (sSCell).

Aspect 10: The method of any of Aspects 1-9, wherein transmitting the indication associated with the non-uplink transmission state comprises transmitting the indication via one or more of: a radio resource control (RRC) communication, a medium access control (MAC) control element (CE) indication, or UE assistance information.

Aspect 11: The method of any of Aspects 1-10, wherein the UE comprises an aerial UE.

Aspect 12: The method of any of Aspects 1-11, wherein the scheduling for the one or more communications comprises scheduling for the one or more communications with one or more parameters associated with the non-uplink transmission state based at least in part on one or more of: a location of the UE, an elevation of the UE, or a current time of day.

Aspect 13: The method of any of Aspects 1-12, wherein the scheduling for the one or more communications is based at least in part on one or more parameters associated with the non-uplink transmission state, and wherein the one or more parameters are based at least in part on a configuration from a network node.

Aspect 14: A method of wireless communication performed by a network node, comprising: receiving an indication associated with a non-uplink transmission state for a user equipment (UE); and transmitting scheduling for one or more communications based at least in part on the indication.

Aspect 15: The method of Aspect 14, wherein the indication associated with the non-uplink transmission state for the UE comprises: a request to initiate the non-uplink transmission state, position information associated with a location of the UE, or an indication of the non-uplink transmission state.

Aspect 16: The method of Aspect 15, wherein the indication associated with the non-uplink transmission state comprises an indication of one or more of: a location of the UE, or an elevation of the UE.

Aspect 17: The method of any of Aspects 14-16, wherein the one or more communications comprise one or more of: only downlink communications, uplink communications having reduced transmission power, uplink communications associated with a proper subset of channel-types, or uplink reference signals.

Aspect 18: The method of any of Aspects 14-17, wherein the indication of the non-uplink transmission state is associated with one or more of: one or more cells, one or more component carriers, one or more channel-types, or one or more bandwidth parts.

Aspect 19: The method of any of Aspects 14-18, wherein a link between the UE and the network node includes multiple cells and wherein the non-uplink transmission state is associated with a proper subset of the multiple cells, wherein the link between the UE and the network node includes multiple component carriers and wherein the non-uplink transmission state is associated with a proper subset of the multiple component carriers, or wherein the link between the UE and the network node includes multiple bandwidth parts (BWPs) and wherein the non-uplink transmission state is associated with a proper subset of the multiple BWPs.

Aspect 20: The method of Aspect 19, wherein transmitting the scheduling for the one or more communications comprises transmitting an allocation for one or more uplink communications via a cell of the multiple cells that is not included in the proper subset.

Aspect 21: The method of Aspect 19, wherein transmitting the scheduling for the one or more communications comprises transmitting one or more of: an indication to perform a cell switch to a new cell to use one or more resources of the new cell for one or more uplink communications, or an indication of an allocation for one or more uplink communications via a cell of the multiple cells that is not included in the proper subset.

Aspect 22: The method of Aspect 21, wherein transmitting the indication of the allocation for the one or more uplink communications via the cell that is not included in the proper subset comprises transmitting the indication of the allocation via one or more of: a downlink control information (DCI) message, or a configuration of a switching secondary cell (sSCell).

Aspect 23: The method of any of Aspects 14-22, wherein receiving the indication associated with the non-uplink transmission state comprises receiving the indication via one or more of: a radio resource control (RRC) communication, a medium access control (MAC) control element (CE) indication, or UE assistance information.

Aspect 24: The method of any of Aspects 14-23, wherein the UE comprises an aerial UE.

Aspect 25: The method of any of Aspects 14-24, wherein the scheduling for the one or more communications comprises scheduling for the one or more communications with one or more parameters associated with the non-uplink transmission state based at least in part on one or more of: a location of the UE, an elevation of the UE, or a current time of day.

Aspect 26: The method of any of Aspects 14-25, wherein the scheduling for the one or more communications is based at least in part on one or more parameters associated with the non-uplink transmission state, and wherein the one or more parameters are based at least in part on a configuration transmitted from the network node.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors, coupled to the one or more memories, configured to cause the UE to:
transmit an indication associated with a non-uplink transmission state for the UE; and
perform one or more communications in accordance with the indication.

2. The apparatus of claim 1, wherein the indication associated with the non-uplink transmission state for the UE comprises at least one of:
a request to initiate the non-uplink transmission state,
position information associated with a location of the UE, or
an indication of the non-uplink transmission state.

3. The apparatus of claim 2, wherein the indication of the non-uplink transmission state comprises an indication of one or more of:
a location of the UE, or
an elevation of the UE.

4. The apparatus of claim 1, wherein the one or more communications comprise one or more of:
only downlink communications,
uplink communications having reduced transmission power,
uplink communications associated with a proper subset of channel-types, or
uplink reference signals.

5. The apparatus of claim 1, wherein the indication associated with the non-uplink transmission state is associated with one or more of:
one or more cells,
one or more component carriers,
one or more channel-types, or
one or more bandwidth parts.

6. The apparatus of claim 1, wherein a link between the UE and a network node includes multiple cells and wherein the non-uplink transmission state is associated with a proper subset of the multiple cells,
wherein the link between the UE and the network node includes multiple component carriers and wherein the non-uplink transmission state is associated with a proper subset of the multiple component carriers, or
wherein the link between the UE and the network node includes multiple bandwidth parts (BWPs) and wherein the non-uplink transmission state is associated with a proper subset of the multiple BWPs.

7. The apparatus of claim 6, wherein the one or more processors, to cause the UE to receive the scheduling for the one or more communications, are configured to cause the UE to receive an allocation for one or more uplink communications via a cell of the multiple cells that is not included in the proper subset.

8. The apparatus of claim 6, wherein the one or more processors, to cause the UE to receive the scheduling for the one or more communications, are configured to cause the UE to receive one or more of:
an indication to perform a cell switch to a new cell to use one or more resources of the new cell for one or more uplink communications, or
an indication of an allocation for one or more uplink communications via a cell of the multiple cells that is not included in the proper subset.

9. The apparatus of claim 8, wherein the one or more processors, to cause the UE to receive the indication of the allocation for the one or more uplink communications via the cell that is not included in the proper subset, are configured to cause the UE to receive the indication of the allocation via one or more of:
a downlink control information (DCI) message, or
a configuration of a switching cell.

10. The apparatus of claim 1, wherein the one or more processors, to cause the UE to transmit the indication associated with the non-uplink transmission state, are configured to cause the UE to transmit the indication via one or more of:
a radio resource control (RRC) communication,
a medium access control (MAC) control element (CE) indication, or
UE assistance information.

11. The apparatus of claim 1, wherein the UE comprises an aerial UE.

12. The apparatus of claim 1, wherein the one or more processors are further configured to cause the UE to schedule for the one or more communications with one or more parameters associated with the non-uplink transmission state based at least in part on one or more of:
a location of the UE,
an elevation of the UE, or
a current time of day.

13. The apparatus of claim 1, wherein the scheduling for the one or more communications is based at least in part on one or more parameters associated with the non-uplink transmission state, and
wherein the one or more parameters are based at least in part on a configuration from a network node.

14. The apparatus of claim 1, wherein the non-uplink transmission state is associated with an entry of the UE into a no-transmit zone (NTZ).

15. An apparatus for wireless communication at a network node, comprising:
one or more memories; and
one or more processors, coupled to the one or more memories, configured to cause the network node to:
receive an indication associated with a non-uplink transmission state for a user equipment (UE); and
transmit scheduling for one or more communications based at least in part on the indication.

16. The apparatus of claim 15, wherein the indication associated with the non-uplink transmission state for the UE comprises:
a request to initiate the non-uplink transmission state,
position information associated with a location of the UE, or
an indication of the non-uplink transmission state.

17. The apparatus of claim 16, wherein the indication associated with the non-uplink transmission state comprises an indication of one or more of:
a location of the UE, or
an elevation of the UE.

18. The apparatus of claim 15, wherein the one or more communications comprise one or more of:
only downlink communications,
uplink communications having reduced transmission power,
uplink communications associated with a proper subset of channel-types, or uplink reference signals.

19. The apparatus of claim 15, wherein the indication of the non-uplink transmission state is associated with one or more of:
one or more cells,
one or more component carriers,
one or more channel-types, or
one or more bandwidth parts.

20. A method of wireless communication performed by a user equipment (UE), comprising:
transmitting an indication associated with a non-uplink transmission state for the UE; and
perform one or more communications based at least in part on the indication.
